(19) United States
(12) Patent Application Publication
(10) Pub. No.: US 2015/0065201 A1
(43) Pub. Date: Mar. 5, 2015

(54) WIRELESS COMMUNICATION TERMINAL AND METHOD FOR SUPPLYING POWER THEREOF

(71) Applicant: SAMSUNG SDI CO., LTD., Yongin-si (KR)

(72) Inventors: Jeong-Seop LEE, Yongin-si (KR); Seok-Gyun CHANG, Yongin-si (KR); Eun-Joo KWAK, Yongin-si (KR); Myung-Sook KWON, Yongin-si (KR); Sung-Gyu SHIN, Yongin-si (KR)

(21) Appl. No.: 14/469,921

(22) Filed: Aug. 27, 2014

(30) Foreign Application Priority Data
Aug. 28, 2013 (KR) 10-2013-0102177

(51) Int. Cl. H04W 52/02; H04M 1/02

(52) U.S. Cl. CPC H04W 52/0296; H04M 1/0262; H04W 52/027; H04M 2001/0204
USPC 455/566; 455/572; 455/573

(57) ABSTRACT

There are provided a wireless communication terminal and a method for supplying power thereof. The wireless communication terminal includes a main battery, an auxiliary battery and a controller. The main battery is attachably/detachably coupled to the terminal to supply power to the terminal. The auxiliary battery is built in the terminal. The controller supplies power to the terminal, using the auxiliary battery, when the main battery is separated from the terminal or when the main battery is discharged. In the wireless communication terminal, the main battery is a high-power and high-capacity battery, and the auxiliary battery is a low-power and low-capacity battery.

### CROSS-REFERENCE TO RELATED APPLICATION

Korean Patent Application No. 10-2013-0102177, filed on Aug. 28, 2013, in the Korean Intellectual Property Office, and entitled: “Wireless Communication Terminal and Method For Supplying Power Thereof,” is incorporated by reference herein in its entirety.

### BACKGROUND

1. Field

Embodiments relate to a wireless communication terminal and a method for supplying power thereof, and more particularly, to a wireless communication terminal with a built-in auxiliary battery and a method for supplying power thereof.

2. Description of the Related Art

A wireless communication terminal is operated under power of a charged battery. When the power of the battery is consumed, a user charges the battery through a charger, etc., or separates the battery from the wireless communication terminal and then mounts a separate charged battery in the wireless communication terminal.

As specifications of a wireless communication terminal increase, various additional functions including data communication, etc., as well as voice communication, which users desire, have recently been added to the wireless communication terminal. The wireless communication terminal refers to a terminal with which voice communication is possible while being carried by a person, such as a mobile communication terminal, a personal communication service (PCS), a personal digital assistant (PDA), a smart phone, a next-generation mobile communication terminal, or a wireless LAN terminal.

As various additional functions described above are added to the wireless communication terminal, users frequently use the wireless communication terminal for types of communication, e.g., data communication, other than voice communication. However, such usage results in accelerated discharge of a battery built in the wireless communication terminal.

Accordingly, there frequently occurs a problem in that when a user performs an important voice communication, the voice communication is cut off due to the discharged battery. In this case, the user cannot continue the voice communication without replacing the discharged battery with a new battery charged or charging the battery, using a charger or the like.

### SUMMARY

One or more embodiments is directed to providing a wireless communication terminal, including: a main battery attachably/detachably coupled to the terminal to supply power to the terminal; an auxiliary battery built in the terminal; and a controller configured to supply power to the terminal, using the auxiliary battery, when the main battery is separated from the terminal or when the main battery is discharged, wherein the main battery is a high-power and high-capacity battery, and the auxiliary battery is a low-power and low-capacity battery.

When the main battery is discharged or when the main battery is separated from the terminal, the controller may convert the output voltage of the terminal into a low-power mode.

When the voltage of the main battery is dropped to a predetermined voltage or less while voice communication is being performed through the terminal, the controller may convert the output voltage of the terminal into the low-power mode.

When the output voltage of the terminal is converted into the low-power mode, the controller may perform at least one of the blocking of a data communication function of the terminal and the conversion of a display device built in the terminal into the low-power mode.

The controller may control the terminal to perform only a predetermined limiting function.

The predetermined limiting function may be a voice communication mode or character transmission/reception mode.

When the main battery is not replaced with another main battery charged within a predetermined time or when the voice communication is not performed through the terminal, after the power is supplied to the terminal, using the auxiliary battery, the controller may turn off the terminal by cutting off the power supplied through the auxiliary battery.

When the main battery is separated from the terminal or when the main battery is discharged, in a state in which the voice communication is performed through the terminal, the controller may supply the power to the terminal, using the auxiliary battery.

The controller may transmit an automatic character message to a companion for the voice communication just before the auxiliary battery is discharged.

The automatic character message may include at least one of a message of informing that the voice communication is terminated by the discharging of the battery and position information of the terminal.

The main battery may be a prismatic battery, and the auxiliary battery may be a pouch-type battery.

The controller may control the auxiliary battery to be charged using the power of the main battery.

One or more embodiments is directed to providing a method for supplying power of a wireless communication terminal, the method including: sensing whether a main battery is separated from the terminal or whether the main battery is discharged; and supplying power to the terminal, using an auxiliary battery built in the terminal, when the main battery is separated from the terminal or when the main battery is discharged, wherein the main battery is a high-power and high-capacity battery, and the auxiliary battery is a low-power and low-capacity battery.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic block configuration diagram of a wireless communication terminal provided with an auxiliary battery according to an embodiment.

FIG. 2 illustrates a flowchart of a method for supplying power of the wireless communication terminal according to an embodiment.

FIG. 3 illustrates a flowchart of a method for supplying power of the wireless communication terminal according to another embodiment.

FIG. 4 illustrates a flowchart of a method for supplying power of the wireless communication terminal according to still another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Further, some of the elements that are not essential to the complete understanding of the invention are omitted for clarity. Also, like reference numerals refer to like elements throughout.

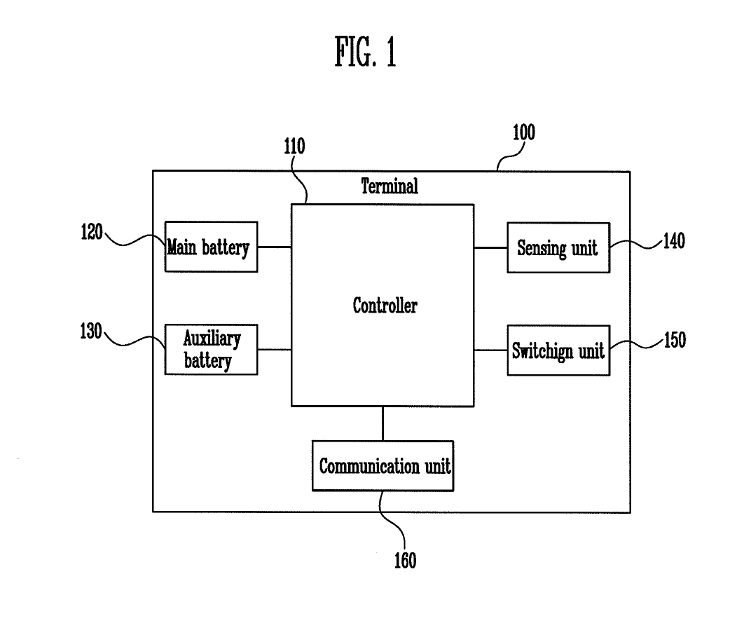

FIG. 1 illustrates a schematic block configuration diagram of a wireless communication terminal provided with an auxiliary battery according to an embodiment. Referring to FIG. 1, the wireless communication terminal 100 may include a controller 110, a main battery 120, an auxiliary battery 130, a sensing unit 140, a switching unit 150 and a communication unit 160.

The wireless communication terminal 100 refers to a terminal with which voice communication is possible while being carried by a person, such as a mobile communication terminal, a personal communication service (PCS), a personal digital assistant (PDA), a smart phone, a next-generation mobile communication terminal, or a wireless LAN terminal. Hereinafter, for convenience of illustration, the wireless communication terminal will be defined as a terminal 100.

The controller 110 performs an operation for voice communication and a power control operation according to this embodiment by controlling a general operation of the terminal 100.

The main battery 120 supplies power to the terminal 100 by being attachably/detachably coupled to the terminal 100. The main battery 120 may be a high-power and high-capacity battery as a power source which mainly supplies power to the terminal 100.

In order to implement the high-power and high-capacity battery, the main battery 120 may be a prismatic lithium ion battery or prismatic lithium polymer battery. However, as will be apparent to those skilled in the art, various types of batteries may exist in order to implement the high-power and high-capacity battery.

The auxiliary battery 130 may be built in a main body of the terminal 100. When the main battery 120 is discharged or is separated from the terminal 100, the auxiliary battery 130 temporarily supplies power to the terminal 100. That is, the auxiliary battery 130 continuously supplies power to the terminal 100 even when the power is not supplied to the terminal 100 through the main battery 120 during user's voice communication, so that the user's voice communication can be performed without interruption.

Since the auxiliary battery 130 is built in the terminal 100 to assist voice communication to be performed without interruption, the auxiliary battery 130 may be implemented as a low-power and low-capacity battery, as compared with the main battery 120. In this case, the controller 110 converts the output voltage of the terminal 100 into a low-power mode when the power is supplied to the terminal 100 by the auxiliary battery 130 so that the terminal 100 can also be operated using the low-power of the auxiliary battery 130. This will be described in detail later.

In order to implement the low-power and low-capacity battery, the auxiliary battery 130 may be a pouch-type lithium polymer battery or pouch-type lithium polymer battery, but is not limited thereto.

According to an embodiment, the controller 110 may control the auxiliary battery 130 to be charged through an external charger coupled to the terminal 100 or to be charged using the power of the main battery 120, so that the auxiliary battery 130 can always maintain a full-charge stage.

The sensing unit 140 is configured to sense when the main battery 120 is discharged or separated from the terminal 100, and to transmit to the controller 110, a sensing signal with respect to the sensed result. The sensing unit 140 may detect whether the main battery 120 is discharged by measuring a voltage of the main battery 120. The sensing unit 140 may detect whether the main battery 120 is separated from the terminal 100, using a mechanical switch, circuit device, or the like.

The switching unit 150 is controlled by the controller 110 and enables power to be supplied to the terminal 100 through the main battery 120 or the auxiliary battery 130. The switching unit 150 may be implemented in various forms.

The communication unit 160 enables voice communication to be performed through wireless communications between a base station and the wireless communication terminal.

Hereinafter, the operation of the controller 110 which enables voice communication to be performed without interruption even when the main battery 120 is discharged or separated from the terminal 100 will be described in detail.

According to an embodiment, the controller 110 may control the auxiliary battery 130 to supply power to the terminal 100 when the main battery 120 is separated from the terminal 100 or when the main battery 120 is discharged.

More specifically, when receiving, from the sensing unit 140, information that the main battery 120 has been separated from the terminal 100 or has been discharged, the controller 110 controls the switching unit 150 so that the power can be supplied to the terminal 100 from the auxiliary battery 130.

Thus, power is supplied to the terminal 100 even when the main battery 120 is discharged or is separated from the terminal 100 during the user's voice communication through the terminal 100, so that the voice communication can be continued without interruption.

According to an embodiment, the controller 110 may convert the output voltage of the terminal 100 into a low-power mode when the main battery 120 is separated from the terminal 100 or is discharged, so that the voice communication can be maximally continued using the auxiliary battery 130.

The low-power mode is a mode in which the terminal 100 can be operated with the minimum power. When the output voltage of terminal 100 is converted into the low-power mode, the terminal 100 is controlled to perform only a function related to the voice communication, and other additional functions performed by the terminal 100 are blocked, so that the terminal can also be operated with low power. Thus, the terminal 100 can be operated using the low-power auxiliary battery 130 in the low-power mode of the terminal 100.

For example, when the output voltage of the terminal 100 is converted into the low-power mode, the controller 110 may perform at least one of the blocking of a data communication function of the terminal 100 and the conversion of a display device built in the terminal into the low-power mode, thereby minimizing power consumption of the terminal 100. The terminal 100 continuously consumes the power of the battery by updating information on an application, etc., which is built in the terminal 100, through data communication, etc., or tracing the position of the terminal 100. Thus, the controller 110 can block the data communication function so that the power consumed by the data communication is minimized. Further, the brightness of the display device built in the terminal 100 can be maximally lowered by converting the output voltage of the display device into the low-power mode, and the power consumption of the terminal 100, caused by the display device, can be minimized by changing the color of the display device into a color with low power consumption.

Accordingly, the controller 110 converts the output voltage of the terminal 100 into the low-power mode, so that it is possible to maximally secure the time when the voice communication can be performed through the auxiliary battery 130.

Additionally or alternatively, when the sensing unit 140 detects that the voltage of the main battery 120 drops to a predetermined voltage or less when the user performs the voice communication, using the main battery 120, the controller 110 may convert the output voltage of the terminal 100 into the low-power mode. That is, when the remaining capacity of the main battery 120 has been reduced such that the voltage of the main battery 120 drops to a predetermined voltage or less, the controller 110 previously converts the output voltage of the terminal 100 into the low-power voltage, so as to enable the user to secure a certain time of the voice communication through the main battery 120.

According to an embodiment, when the output voltage of the terminal 100 is converted into the low-power mode, the controller 110 may control the terminal 100 to perform only a predetermined limiting function. The predetermined limiting function may be a voice communication mode or character transmission/reception mode. Thus, when the power is supplied to the terminal 100 through the auxiliary battery 130, the user can perform voice communication or character transmission through the terminal 100 or replacement of the main battery 120 without turning off the terminal 100.

According to an embodiment, after the power is supplied to the terminal 100, using the auxiliary battery 130, the controller 110 may turn off the terminal 100 by cutting off the power supplied through the auxiliary battery 130 when another main battery charged is not replaced within a predetermined time or when the voice communication through the terminal 100 is not performed for a predetermined time or more.

The auxiliary battery 130 allows the terminal 100 not to be turned off while the user is replacing the main battery 120. In addition, when the user performs voice communication, the auxiliary battery 130 allows the voice communication to be performed without interruption. Thus, when the main battery is not replaced within the predetermined time or when the voice communication is not performed for the predetermined time, the controller 110 cuts off the power supplied through the auxiliary battery 130, to prevent unnecessary power consumption of the auxiliary battery 130. Thus, when an emergency situation occurs or when an important voice communication is performed even though the main battery 120 is discharged, the controller 110 can again turn on the terminal 100 through the auxiliary battery 130 and perform an operation of voice communication, character message transmission, or the like.

According to another embodiment, when the main battery 120 is separated from the terminal 100 or is discharged in a state in which the voice communication is performed through the terminal 100, the controller 110 may supply power to the terminal 100 using the auxiliary battery 130.

That is, the supply of power to the terminal 100 through the auxiliary battery 130 is limited to a case where the user performs voice communication, so that the controller 110 prevents unnecessary power consumption of the auxiliary battery 130, and enables the voice communication to be maximally performed without interruption using the auxiliary battery 130.

According to an embodiment, when the voice communication of the terminal 100 is performed using the auxiliary battery 130, the controller 110 may allow an automatic character message to be transmitted to a companion for the voice communication just before the auxiliary battery 130 is discharged.

Here, the automatic character message may include at least one of a message of informing that the voice communication is terminated by the discharging of the battery and position information of the terminal. In addition, the automatic character message may be a message previously set by the user.

When voice communication is cut off while the voice communication is being performed using the auxiliary battery 130, the controller 110 enables the companion to recognize that the voice communication has been terminated by the discharging of the battery. Further, the controller 110 enables the position information of the terminal to be transmitted to the companion, so that the user can inform the companion of the user's position even when the battery is discharged in an emergency situation or the like.

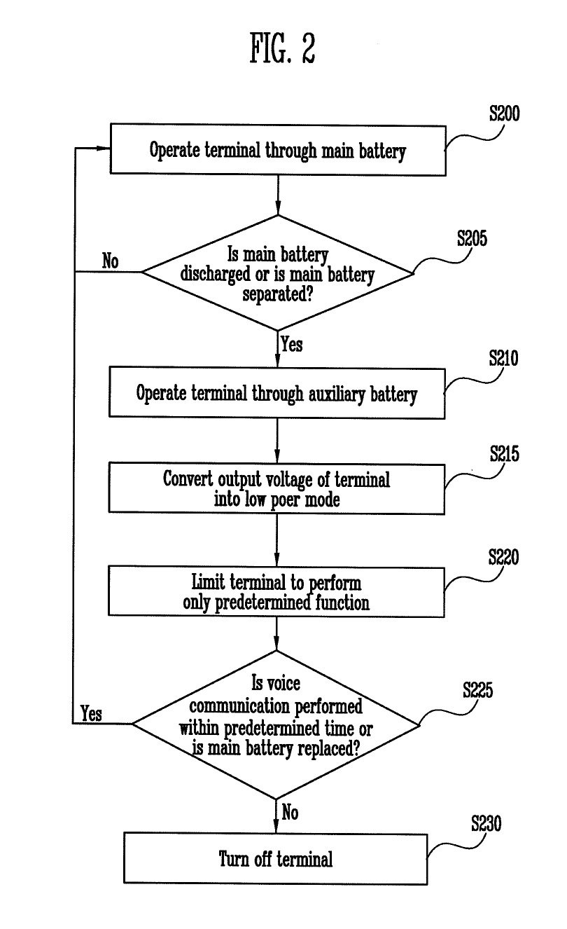

FIG. 2 illustrates a flowchart of a method for supplying power of the wireless communication terminal according to an embodiment.

Referring to FIG. 2, in operation S200, the terminal 100 is operated through the main battery 120.

In operation S205, the sensing unit 140 senses whether the main battery 120 is discharged or is separated from the terminal 100, and transmits sensing information on the sensed result to the controller 110. When the sensing unit 140 determines the main battery 120 is operable, the flow returns to operation S200. When the sensing unit 140 determines the main battery is no longer operable, the flow proceeds to operation S210.

In operation S210, the controller 110 supplies power to the terminal 100, using the auxiliary battery 130, so that the terminal 100 can be operated through the auxiliary battery 130.

Subsequently, in operation S215, the controller 110 converts the output voltage of the terminal 100 into a low-power mode, and controls the terminal 100 to be also operated through the low-power and low-capacity auxiliary battery 130.

In operation S220, the controller 110 controls the terminal 100 to perform only a predetermined function. The predetermined function may be a voice communication mode or character transmission/reception mode in which a user can perform voice communication or character transmission through the terminal or replacement of the main battery 120 without turning off the terminal 100.

In operation S225, the controller 110 decides whether the voice communication through the terminal 100 is performed within a predetermined time or whether the main battery 120 is replaced with another main battery.

When the voice communication is not performed within the predetermined time or when the main battery 120 is not replaced with another main battery, in operation S230, the controller 100 turns off the terminal 100, to prevent unnecessary power consumption of the auxiliary battery 130. When the main battery 120 is replaced, the flow returns to operation S200 to control the terminal 100 to be operated through the main battery 120.

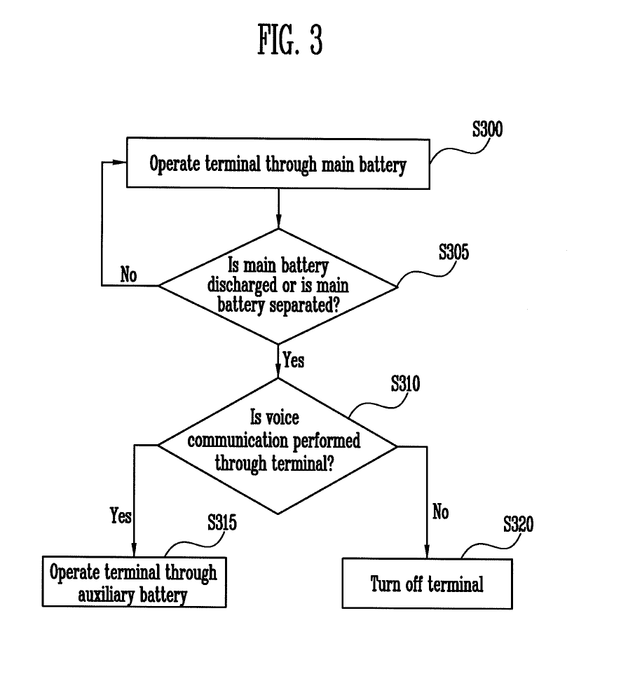

FIG. 3 illustrates a flowchart of a method for supplying power of the wireless communication terminal according to another embodiment.

Referring to FIG. 3, in operation S300, the terminal 100 is operated through the main battery 120.

In operation S305, the sensing unit 140 senses whether the main battery 120 is discharged or separated from the terminal 100, and transmits sensing information on the sensed result to the controller 110. When the sensing unit 140 determines the main battery 120 is operable, the flow returns to operation S300. When the sensing unit 140 determines the main battery is no longer operable, the flow proceeds to operation S310

In operation S310, the controller 110 decides whether voice communication is performed through the terminal 100. When voice communication is performed through the terminal 100, in operation S315, the controller 110 supplies power to the terminal 100, using the auxiliary battery 130, so that the voice communication can be performed without pause.

Operation after operation S315 may be performed identically to operations S215 to S230 of FIG. 2, and therefore, their detailed descriptions will be omitted.

When voice communication is not performed through the terminal 100, in operation S320, the controller 110 turns off the terminal 100, to prevent unnecessary power consumption of the auxiliary battery 130. When an emergency situation occurs or when an important voice communication is necessarily performed, a user may again turn on the terminal 100 through the auxiliary battery 130, and perform an operation of voice communication, character message transmission, etc.

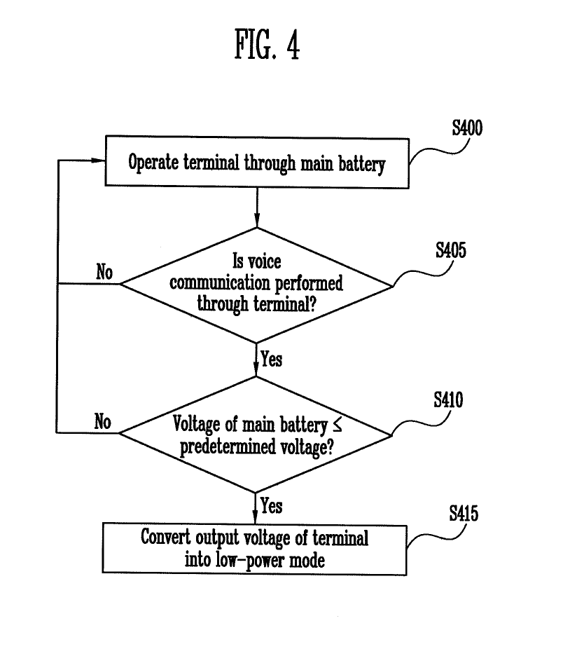

FIG. 4 illustrates a flowchart of a method for supplying power of the wireless communication terminal according to still another embodiment.

Referring to FIG. 4, in operation S400, the terminal 100 is operated through the main battery 120.

In operation S405, the controller 110 decides whether voice communication is performed through the terminal 100.

When voice communication is performed through the terminal 100, in operation S410, the sensing unit 140 senses whether the voltage of the main battery 120 is a predetermined voltage or less, and transmits sensing information to the controller 110.

When the voltage of the main battery 120 is the predetermined voltage or less, in operation S415, the controller 110 converts the output voltage of the terminal 100 into a low-power mode. Otherwise, the flow returns to operation S400.

That is, when the remaining capacity of the main battery 120 is reduced such that the voltage of the main battery 120 has dropped to a predetermined voltage or less, the controller 110 converts the output voltage of the terminal 100 into the low-power voltage, so as to enable the user to secure a certain time of the voice communication through the main battery 120.

Operations following operation S415 may be performed identically to operations S205 to S230 of FIG. 2, and therefore, their detailed descriptions will be omitted.

By way of summation and review, the wireless communication terminal and the method for supplying power thereof according to one or more embodiments, the terminal is operated using the low-power and low-capacity auxiliary battery even when the high-power and high-capacity main battery is consumed or removed during voice communication, so that the user can perform the voice communication without pause. Accordingly, voice communication can be maximally performed without interruption even when the main battery of the terminal is discharged or when the main battery of the terminal is separated from the terminal.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A wireless communication terminal, comprising:
a main battery attachably/detachably coupled to the terminal to supply power to the terminal;
an auxiliary battery built in the terminal; and
a controller configured to supply power to the terminal, using the auxiliary battery, when the main battery is separated from the terminal or when the main battery is discharged,
wherein the main battery is a high-power and high-capacity battery, and the auxiliary battery is a low-power and low-capacity battery.

2. The wireless communication terminal as claimed in claim 1, wherein the controller converts an output voltage of the terminal into a low-power mode based on a condition of the main battery.

3. The wireless communication terminal as claimed in claim 2, wherein the condition includes at least one of a voltage of the main battery dropping to a predetermined voltage or less while voice communication is being performed through the terminal, the main battery being separated from the terminal, or the main battery being discharged.

4. The wireless communication terminal as claimed in claim 2, wherein, when the output voltage of the terminal is converted into the low-power mode, the controller performs at least one of blocking a data communication function of the terminal and converting a display device built in the terminal into the low-power mode.

5. The wireless communication terminal as claimed in claim 4, wherein the controller controls the terminal to perform only a predetermined limiting function.

6. The wireless communication terminal as claimed in claim 5, wherein the predetermined limiting function is a voice communication mode or character transmission/reception mode.

7. The wireless communication terminal as claimed in claim 1, wherein, when the main battery is not replaced with a charged main battery within a predetermined time or when voice communication is not performed through the terminal, after the power is supplied to the terminal using the auxiliary battery, the controller turns off the terminal by cutting off the power supplied through the auxiliary battery.

8. The wireless communication terminal as claimed in claim 1, wherein, when the main battery is separated from the terminal or when the main battery is discharged, and when voice communication is performed through the terminal, the controller supplies power to the terminal using the auxiliary battery.

9. The wireless communication terminal as claimed in claim 1, wherein the controller transmits an automatic character message to a companion to voice communication just before the auxiliary battery is discharged.

10. The wireless communication terminal as claimed in claim 9, wherein the automatic character message includes a message informing the companion of at least one of that the voice communication is terminated due to the discharging of the battery and position information of the terminal.

11. The wireless communication terminal as claimed in claim 1, wherein the main battery is a prismatic battery and the auxiliary battery is a pouch-type battery.

12. The wireless communication terminal as claimed in claim 1, wherein the controller controls the auxiliary battery to be charged using the power of the main battery.

13. A method for supplying power of a wireless communication terminal, the method comprising:
sensing whether a main battery is separated from the terminal or whether the main battery is discharged; and
supplying power to the terminal using an auxiliary battery built in the terminal when the main battery is separated from the terminal or when the main battery is discharged,
wherein the main battery is a high-power and high-capacity battery, and the auxiliary battery is a low-power and low-capacity battery.

14. The method as claimed in claim 13, further comprising converting an output voltage of the terminal into a low-power mode based on a condition of the main battery.

15. The method as claimed in claim 13, wherein the condition includes at least one of a voltage of the main battery dropping to a predetermined voltage or less while voice communication is being performed through the terminal, the main battery being separated from the terminal, or the main battery being discharged.

16. The method as claimed in claim 15, further comprising controlling the terminal to perform only a predetermined limited function including at least one of a voice communication mode and a character transmission/reception mode, after the output voltage of the terminal is converted into the low-power mode.

17. The method as claimed in claim 16, wherein the low-power mode includes at least one of blocking a data communication function of the terminal and a low-power mode of a display device built in the terminal.

18. The method as claimed in claim 13, further comprising turning off the terminal by cutting off the power supplied through the auxiliary battery, when the main battery is not replaced with another main battery charged within a predetermined time or when voice communication is not performed through the terminal, after the supplying of the power to the terminal using the auxiliary battery.

19. The method as claimed in claim 13, wherein supplying power to the terminal using the auxiliary battery is performed when the main battery is separated from the terminal or when the main battery is discharged while voice communication is being performed through the terminal.
